(19) United States
(12) Patent Application Publication
(10) Pub. No.: US 2015/0199022 A1
(43) Pub. Date: Jul. 16, 2015

(54) GESTURE RECOGNITION FOR DRILLING DOWN INTO METADATA IN AUGMENTED REALITY DEVICES

(71) Applicant: fisoc, Inc., Austin, TX (US)

(72) Inventors: Wesley Gottesman, Austin, TX (US); Brian Rainey, Austin, TX (US); Jay P. Valanju, Austin, TX (US); David H. Fruhling, II, Austin, TX (US); Daniel Edward Kim, Austin, TX (US)

(21) Appl. No.: 14/589,567

(22) Filed: Jan. 5, 2015

Related U.S. Application Data
(60) Provisional application No. 61/926,543, filed on Jan. 13, 2014.

(51) Int. Cl. G06F 3/01; G06F 3/042; G06K 9/00

(52) U.S. Cl. CPC G06F 3/017; G06K 9/00355; G06F 3/042

(57) ABSTRACT

A touchless interaction with a computer is desirable as augmented reality devices become more of a reality. A user gesture may be recognizable using a built-in camera. A processor identifies a user pre-gesture based on digital images from the camera. The processor associates a point of interest on the display according to one of a shape and a position of the user pre-gesture. The processor identifies a change from the user pre-gesture to a user gesture based on the digital images from the camera, and the processor executes an appropriate action or program based on the user gesture.

### CROSS-REFERENCES TO RELATED APPLICATIONS

This application claims the benefit of U.S. Provisional Patent Application Ser. No. 61/926,543, filed Jan. 13, 2014, the entire content of which is herein incorporated by reference.

### STATEMENT REGARDING FEDERALLY SPONSORED RESEARCH OR DEVELOPMENT

(NOT APPLICABLE)

### BACKGROUND OF THE INVENTION

The invention relates to augmented reality devices and, more particularly, to touchless gesture recognition using a built-in camera for executing an action or program.

As augmented reality devices become more of a reality, touchless methods of interacting with software become more important. While voice recognition is one possible way of interaction, the built-in camera in many portable devices has not been used to recognize gestures.

Gestures provide an opportunity for users to signal to the device their interests with limited potential distortions, increasing accuracy, as well as limiting the possible interference by outside noise, thereby increasing reliability.

### BRIEF SUMMARY OF THE INVENTION

An important component for success of the interface is an easily recognizable gesture. A “duckbill” gesture is exemplary. Shaping a user's hand into the shape of the bill of the duck, the user can point to point of interest elements in the field of vision. The system would treat the point as an analog to a mouse pointer. Using the duckbill gesture as an exemplary user gesture, to enact a mouse click, the user would “explode” his fingers.

In a merchant funded debit rewards program or the like, this could be used to point to a restaurant or merchant, and “click” to bring up a detailed view of the location.

In an exemplary embodiment, a method of recognizing a touchless interaction is performed with a computer including a processor, a display, a memory storing computer programs executable by the processor, and a camera capturing digital images and delivering signals representative of the digital images to the processor. The method includes the steps of (a) the processor identifying a user pre-gesture based on the digital images from the camera; (b) the processor associating a point of interest on the display according to one of a shape and a position of the user pre-gesture; (c) the processor identifying a change from the user pre-gesture to a user gesture based on the digital images from the camera; and (d) the processor executing an appropriate one of the computer programs based on the user gesture.

The user pre-gesture may include a convergence point, where step (b) is practiced by associating the convergence point with an object on the display. Step (a) may be practiced by capturing an image with the camera of the user's hand with at least two fingers of the user's hand converged such that tips of the at least two fingers are in proximity to or are touching one another, the convergence point being where the at least two fingers of the user's hand are converged. Step (c) may be practiced by identifying the change from the user pre-gesture to the user gesture by identifying an image of the user's hand captured by the camera of the at least two fingers spreading out from the convergence point.

Step (a) may be practiced by capturing an image with the camera of the user's hand with all fingers of the user's hand converged such that the tips of the fingers are in proximity to or are touching one another, the convergence point being where the fingers of the user's hand are converged. In this context, step (c) may be practiced by identifying the change from the user pre-gesture to the user gesture by identifying an image of the user's hand captured by the camera of the fingers spreading out from the convergence point.

The method may further include, after step (c), a step of executing the change from the user pre-gesture to the user gesture as a mouse click.

Steps (a) and (c) may be practiced in a field of vision of the camera without the user touching the display.

In another exemplary embodiment, a computer system for recognizing a touchless interaction includes a processor, a display, a memory storing computer programs executable by the processor, and a camera capturing digital images and delivering signals representative of the digital images to the processor. The processor is programmed to identify a user pre-gesture based on the digital images from the camera and to associate a point of interest on the display according to one of a shape and a position of the user pre-gesture. The processor is programmed to identify a change from the user pre-gesture to a user gesture based on the digital images from the camera, and the processor is programmed to execute an appropriate one of the computer programs based on the user gesture.

In yet another exemplary embodiment, a method of recognizing a touchless interaction with a computer includes the steps of identifying a duckbill gesture of a user's hand based on the digital images of the user's hand from the camera; associating a point of interest on the display according to one of a shape and a position of the duckbill gesture; identifying a change from the duckbill gesture to an exploded gesture based on the digital images of the user's hand from the camera; and executing an appropriate one of the computer programs based on the change.

### BRIEF DESCRIPTION OF THE DRAWINGS

These and other aspects and advantages will be described in detail with reference to the accompanying drawings, in which:

FIG. 1 shows an exemplary display and an exemplary user pre-gesture;

FIG. 2 shows the pre-gesture including a convergence point pointing to an object on the display;

FIG. 3 shows a user change from the pre-gesture to a user gesture;

FIG. 4 shows an exemplary application executed as a consequence of the gesture recognition;

FIG. 5 is a flow chart of the method for processing a dynamic hand gesture; and

FIG. 6 is a schematic diagram of a computer system.

### DETAILED DESCRIPTION OF THE INVENTION

With reference to the drawings, the system and methodology according to preferred embodiments of the invention utilize a computer's built-in video camera to recognize a dynamic hand gesture. The dynamic hand gesture may be used to point to a point of interest on the computer display in the field of vision of the camera. The system treats the point and hand gesture as an analog to a mouse click.

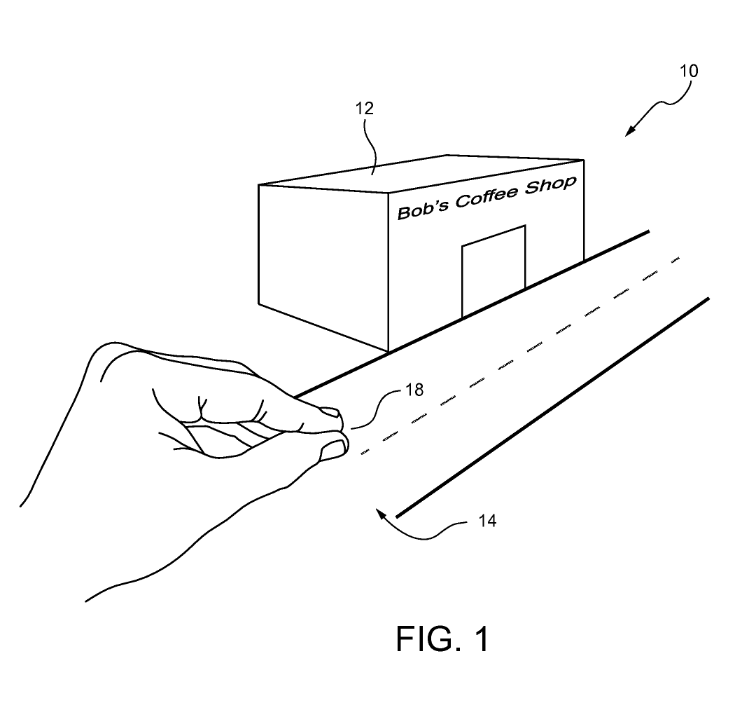

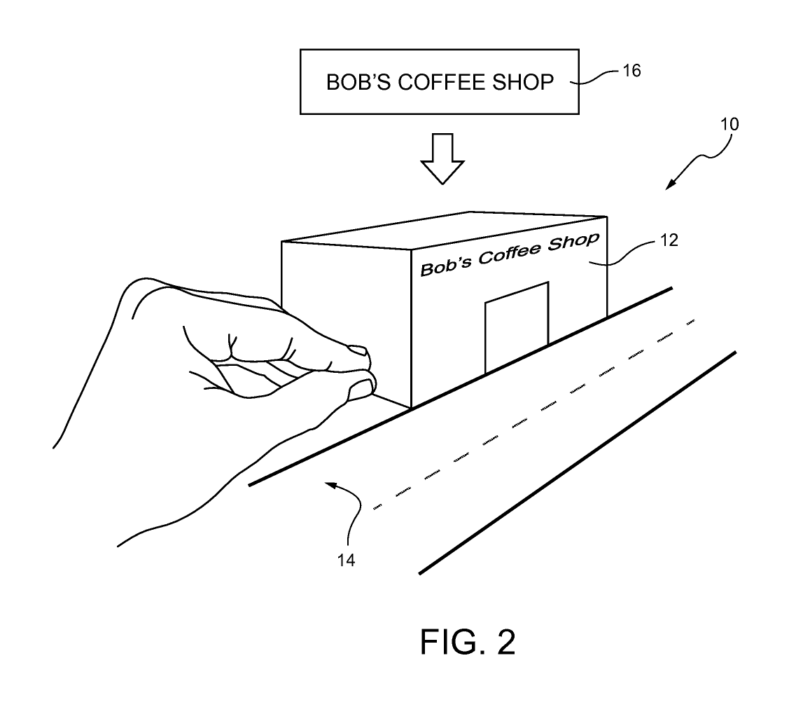

With reference to FIGS. 1 and 2, a computer display screen 10 shows an image with an object 12 (e.g., “Bob's coffee shop”). A user pre-gesture 14 may be identified by the camera, and the system identifies a point of interest 16 according to one of a shape and a position of the user pre-gesture 14. Preferably, the pre-gesture 14 includes a convergence point 18, where associating the point of interest 16 with the pre-gesture 14 is practiced by associating the convergence point 18 with the object 12 on the display.

In the exemplary embodiment shown in the figures, the user pre-gesture is a “duckbill” gesture made by the user's hand where at least two fingers of the user's hand are converged such that tips of the at least two fingers are in proximity to or are touching one another. The convergence point 18 is where the at least two fingers of the user's hand are converged. In the embodiment shown in FIG. 1, the pre-gesture is formed by the user's hand with all fingers of the user's hand converged such that the tips of the fingers are in proximity to or are touching one another, and the convergence point 18 is where the fingers of the user's hand are converged.

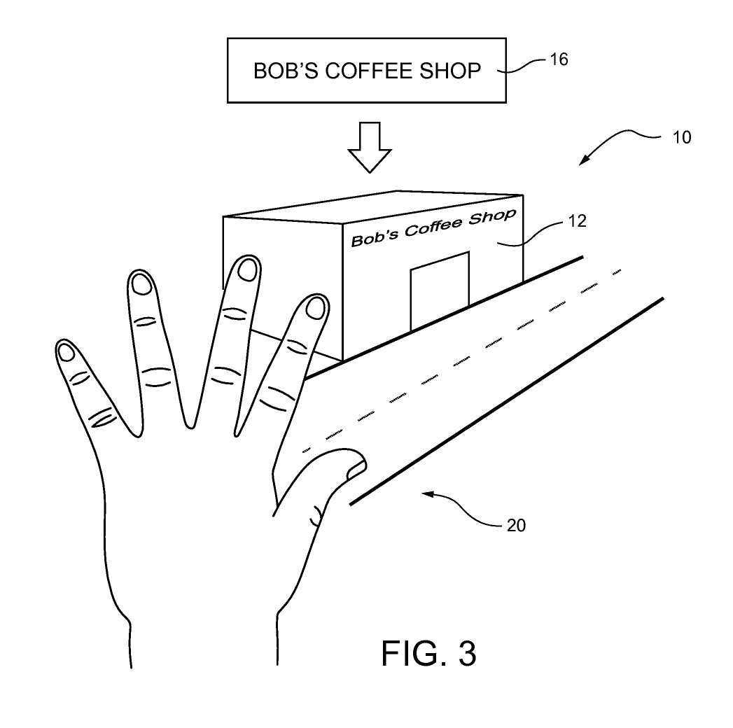

With reference to FIG. 3, the system identifies a change from the user pre-gesture to a user gesture 20 based on digital images from the camera. Subsequently, the system executes an action such as executing a computer program or the like based on the user gesture 20. In the exemplary embodiment, the identification of the change from the user pre-gesture to the user gesture is practiced by identifying an image of the user's hand captured by the camera of the at least two fingers or all fingers spreading out from the convergence point (see FIG. 3). That is, to enact a mouse click using the gesture, the user would “explode” his hand, which positioning would be identified in the images captured by the camera. The change from the user pre-gesture to the user gesture is executed as a mouse click. Preferably, the pre-gesture and gesture are practiced in a field of vision of the camera without the user touching the display.

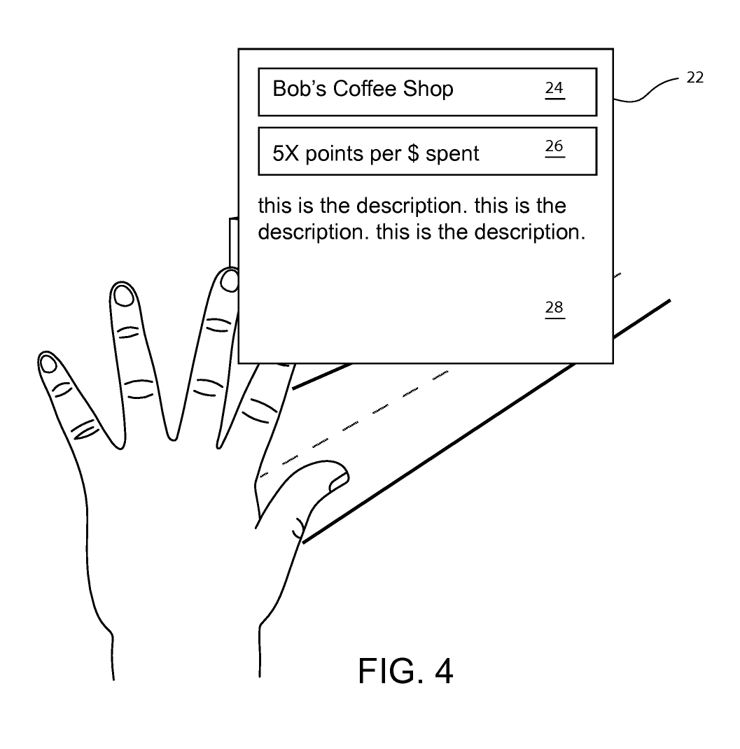

With reference to FIG. 4, once the system recognizes the user gesture, the processor executes a predefined action or program. With reference to FIG. 4, the gesture is used to point to a restaurant or merchant, and the effective “mouse click” brings up metadata or a detailed view of information (22) relating to the selected point of interest. In a merchant funded debit rewards program, the metadata 22 could include an identification of the point of interest 24, an offer or reward 26 and a description 28 of the restaurant or merchant.

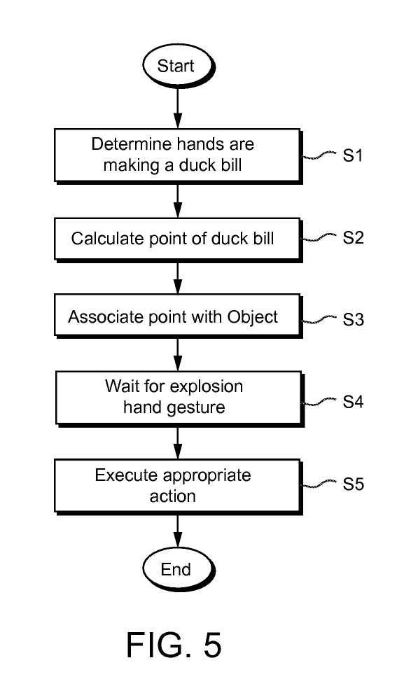

FIG. 5 is a flow chart of the gesture recognition process according to preferred embodiments. In step S1, the system identifies a user pre-gesture (e.g., the duckbill gesture as shown in the drawings) based on the digital images from the camera. The system associates a point of interest on the display according to one of a shape and a position of the user pre-gesture (S2, S3). In step S4, the system waits for the user gesture (e.g., the “explosion” of the user's hand/fingers), and the system identifies a change from the user pre-gesture to the user gesture based on the images from the camera. Once identified, the system executes an appropriate action or computer program based on the user gesture (S5).

The system described with reference to FIGS. 1-5 may be a browser-based system in which a program running on a user's computer (the user's web browser) requests information from a server program running on a system server. The system server sends the requested data back to the browser program, and the browser program then interprets and displays the data on the user's computer screen. The process is as follows:

1. The user runs a web browser program on his/her computer.

2. The user connects to the server computer (e.g., via the Internet). Connection to the server computer may be conditioned upon the correct entry of a password as is well known.

3. The user requests a page from the server computer. The user's browser sends a message to the server computer that includes the following:

the transfer protocol (e.g., http://); and

the address, or Uniform Resource Locator (URL).

4. The server computer receives the user's request and retrieves the requested page, which is composed, for example, in HTML (Hypertext Markup Language).

5. The server then transmits the requested page to the user's computer.

6. The user's browser program receives the HTML text and displays its interpretation of the requested page.

Thus, the browser program on the user's computer sends requests and receives the data needed to display the HTML page on the user's computer screen. This includes the HTML file itself plus any graphic, sound and/or video files mentioned in it. Once the data is retrieved, the browser formats the data and displays the data on the user's computer screen. Helper applications, plug-ins, and enhancements such as Java™ enable the browser, among other things, to play sound and/or display video inserted in the HTML file. The fonts installed on the user's computer and the display preferences in the browser used by the user determine how the text is formatted.

If the user has requested an action that requires running a program (e.g., a search), the server loads and runs the program. This process usually creates a custom HTML page “on the fly” that contains the results of the program's action (e.g., the search results), and then sends those results back to the browser.

Browser programs suitable for use in connection with the system and methodology of the present invention include Mozilla Firefox® and Internet Explorer available from Microsoft® Corp.

While the above description contemplates that each user has a computer running a web browser, it will be appreciated that more than one user could use a particular computer terminal or that a “kiosk” at a central location (e.g., a cafeteria, a break area, etc.) with access to the system server could be provided.

It will be recognized by those in the art that various tools are readily available to create web pages for accessing data stored on a server and that such tools may be used to develop and implement the system described below and illustrated in the accompanying drawings.

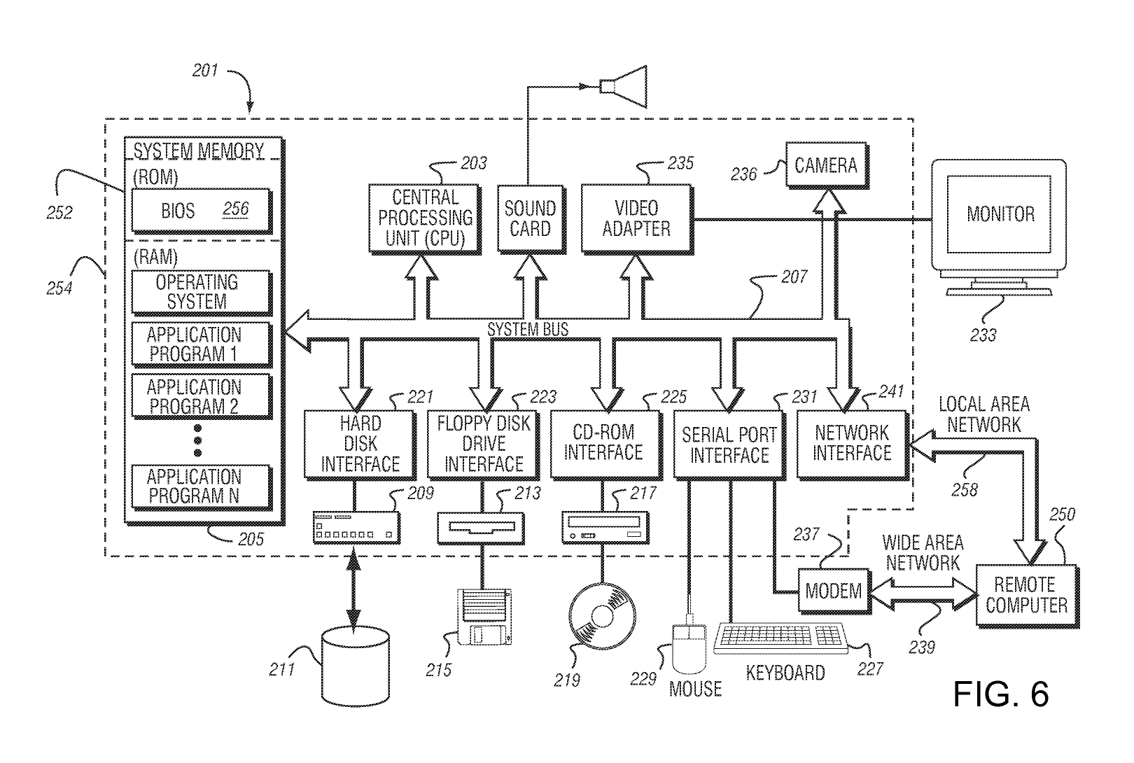

FIG. 6 generally illustrates a computer system 201 suitable for use as the client and server components of the described system. It will be appreciated that the client and server computers will run appropriate software and that the client and server computers may be somewhat differently configured with respect to the processing power of their respective processors and with respect to the amount of memory used. Computer system 201 includes a processing unit 203 and a system memory 205. A system bus 207 couples various system components including system memory 205 to processing unit 203. System bus 207 may be any of several types of bus structures including a memory bus or memory controller, a peripheral bus, and a local bus using any of a variety of bus architectures. System memory 205 includes read only memory (ROM) 252 and random access memory (RAM) 254. A basic input/output system (BIOS) 256, containing the basic routines that help to transfer information between elements within computer system 201, such as during start-up, is stored in ROM 252. Computer system 201 further includes various drives and associated computer-readable media. A hard disk drive 209 reads from and writes to a (typically fixed) magnetic hard disk 211; a magnetic disk drive 213 reads from and writes to a removable or other magnetic disk 215; and an optical disk drive 217 reads from and, in some configurations, writes to a removable optical disk 219 such as a CD ROM or other optical media. Hard disk drive 209, magnetic disk drive 213, and optical disk drive 217 are connected to system bus 207 by a hard disk drive interface 221, a magnetic disk drive interface 223, and an optical drive interface 225, respectively. The drives and their associated computer-readable media provide nonvolatile storage of computer-readable instructions, SQL-based procedures, data structures, program modules, and other data for computer system 201. In other configurations, other types of computer-readable media that can store data that is accessible by a computer (e.g., magnetic cassettes, flash memory cards, digital video disks, Bernoulli cartridges, random access memories (RAMs), read only memories (ROMs) and the like) may also be used.

A number of program modules may be stored on the hard disk 211, removable magnetic disk 215, optical disk 219 and/or ROM 252 and/or RAM 254 of the system memory 205. Such program modules may include an operating system providing graphics and sound APIs, one or more application programs, other program modules, and program data. A user may enter commands and information into computer system 201 through input devices such as a keyboard 227 and a pointing device 229. Other input devices may include a microphone, joystick, game controller, satellite dish, scanner, or the like. A digital camera 236 may also be coupled with the system bus 207 as an input device. These and other input devices are often connected to the processing unit 203 through a serial port interface 231 that is coupled to the system bus 207, but may be connected by other interfaces, such as a parallel port interface or a universal serial bus (USB). A monitor 233 or other type of display device is also connected to system bus 207 via an interface, such as a video adapter 235.

The computer system 201 may also include a modem or broadband or wireless adapter 237 or other means for establishing communications over the wide area network 239, such as the Internet. The modem 237, which may be internal or external, is connected to the system bus 207 via the serial port interface 231. A network interface 241 may also be provided for allowing the computer system 201 to communicate with a remote computing device 250 via a local area network 258 (or such communication may be via the wide area network 239 or other communications path such as dial-up or other communications means). The computer system 201 will typically include other peripheral output devices, such as printers and other standard peripheral devices.

As will be understood by those familiar with web-based forms and screens, users may make menu selections by pointing-and-clicking using a mouse, trackball or other pointing device, or by using the TAB and ENTER keys on a keyboard or using the touchless gesture recognition of the described embodiments. For example, menu selections may be highlighted by positioning the cursor on the selections using a mouse or by using the TAB key. The mouse may be left-clicked to select the selection or the ENTER key may be pressed. Other selection mechanisms including voice-recognition systems, touch-sensitive screens, etc. may be used, and the invention is not limited in this respect.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

1. A method of recognizing a touchless interaction with a computer, the computer including a processor, a display, a memory storing computer programs executable by the processor, and a camera capturing digital images and delivering signals representative of the digital images to the processor, the method comprising:
(a) the processor identifying a user pre-gesture based on the digital images from the camera;
(b) the processor associating a point of interest on the display according to one of a shape and a position of the user pre-gesture;
(c) the processor identifying a change from the user pre-gesture to a user gesture based on the digital images from the camera; and
(d) the processor executing an appropriate one of the computer programs based on the user gesture.

2. A method according to claim 1, wherein the user pre-gesture includes a convergence point, wherein step (b) is practiced by associating the convergence point with an object on the display.

3. A method according to claim 2, wherein step (a) is practiced by capturing an image with the camera of the user's hand with at least two fingers of the user's hand converged such that tips of the at least two fingers are in proximity to or are touching one another, the convergence point being where the at least two fingers of the user's hand are converged.

4. A method according to claim 3, wherein step (c) is practiced by identifying the change from the user pre-gesture to the user gesture by identifying an image of the user's hand captured by the camera of the at least two fingers spreading out from the convergence point.

5. A method according to claim 2, wherein step (a) is practiced by capturing an image with the camera of the user's hand with all fingers of the user's hand converged such that the tips of the fingers are in proximity to or are touching one another, the convergence point being where the fingers of the user's hand are converged.

6. A method according to claim 5, wherein step (c) is practiced by identifying the change from the user pre-gesture to the user gesture by identifying an image of the user's hand captured by the camera of the fingers spreading out from the convergence point.

7. A method according to claim 1, further comprising, after step (c), executing the change from the user pre-gesture to the user gesture as a mouse click.

8. A method according to claim 1, wherein steps (a) and (c) are practiced in a field of vision of the camera without the user touching the display.

9. A computer system for recognizing a touchless interaction, the computer system comprising:
a processor;
a display;
a memory storing computer programs executable by the processor; and
a camera capturing digital images and delivering signals representative of the digital images to the processor, wherein the processor is programmed to identify a user pre-gesture based on the digital images from the camera and to associate a point of interest on the display according to one of a shape and a position of the user pre-gesture, wherein the processor is programmed to identify a change from the user pre-gesture to a user gesture based on the digital images from the camera, and wherein the processor is programmed to execute an appropriate one of the computer programs based on the user gesture.

10. A computer system according to claim 9, wherein the user pre-gesture includes a convergence point, and wherein the processor is programmed to associate the convergence point with an object on the display.

11. A computer system according to claim 10, wherein the camera is controlled by the processor to capture an image of the user's hand with at least two fingers of the user's hand converged such that tips of the at least two fingers are in proximity to or are touching one another, the processor identifying the convergence point where the at least two fingers of the user's hand are converged.

12. A computer system according to claim 11, wherein the processor identifies the change from the user pre-gesture to the user gesture by identifying an image of the user's hand captured by the camera of the at least two fingers spreading out from the convergence point, the processor transforming the change into a request for an executed action.

13. A computer system according to claim 10, wherein the camera is controlled by the processor to capture an image with the camera of the user's hand with all fingers of the user's hand converged such that the tips of the fingers are in proximity to or are touching one another, processor identifying the convergence point being where the fingers of the user's hand are converged.

14. A computer system according to claim 13, wherein the processor identifies the change from the user pre-gesture to the user gesture by identifying an image of the user's hand captured by the camera of the fingers spreading out from the convergence point, the processor transforming the change into a request for an executed action.

15. A computer system according to claim 9, wherein the processor transforms the change from the user pre-gesture to the user gesture into a mouse click.

16. A method of recognizing a touchless interaction with a computer, the computer including a processor, a display, a memory storing computer programs executable by the processor, and a camera capturing digital images and delivering signals representative of the digital images to the processor, the method comprising:
(a) the processor identifying a duckbill gesture of a user's hand based on the digital images of the user's hand from the camera;
(b) the processor associating a point of interest on the display according to one of a shape and a position of the duckbill gesture;
(c) the processor identifying a change from the duckbill gesture to an exploded gesture based on the digital images of the user's hand from the camera; and
(d) the processor executing an appropriate one of the computer programs based on the change.

17. A method according to claim 16, wherein the duckbill gesture includes a convergence point, wherein step (b) is practiced by associating the convergence point with an object on the display.

18. A method according to claim 16, further comprising, after step (c), executing the change from the duckbill gesture to the exploded gesture as a mouse click.
